(19) United States
(12) Patent Application Publication
(10) Pub. No.: US 2013/0044955 A1
(43) Pub. Date: Feb. 21, 2013

(54) IMAGE PROCESSING APPARATUS, IMAGE PROCESSING METHOD, AND COMPUTER PROGRAM

(71) Applicant: Jun Hirai, Tokyo (JP)

(72) Inventor: Jun Hirai, Tokyo (JP)

(73) Assignee: SONY CORPORATION, Tokyo (JP)

(21) Appl. No.: 13/569,347

(22) Filed: Aug. 8, 2012

(30) Foreign Application Priority Data
Aug. 15, 2011 (JP) 2011-177379

(51) Int. Cl. G06K 9/40; G06K 9/46

(52) U.S. Cl. 382/190

(57) ABSTRACT

There is provided an image processing apparatus including an image input unit that inputs an image, a high bandpass filter that extracts a high-band component of the input image, a high-band small amplitude extracting unit that extracts a small amplitude component from the extracted high-band component, a high-band small amplitude adjusting unit that adjust an extracted high-band small amplitude component, an intermediate bandpass filter that extracts an intermediate-band component of the input image, an intermediate-band large amplitude extracting unit that extracts a large amplitude component from the extracted intermediate component, an intermediate-band large amplitude adjusting unit that adjusts an extracted intermediate-band large amplitude component, and an adding unit that adds the adjusted high-band small amplitude component and the adjusted intermediate-band large amplitude component to the input image.

### CROSS-REFERENCE TO RELATED APPLICATION

The present application claims priority from Japanese Patent Application No. JP 2011-177379 filed in the Japanese Patent Office on Aug. 15, 2011, the entire content of which is incorporated herein by reference.

### BACKGROUND

The present disclosure relates to an image processing apparatus, an image processing method, and a computer program that improve image quality of an input image and more particularly, to an image processing apparatus, an image processing method, and a computer program that perform contour correction with respect to an input image such as a movie and enhance fineness and sharpness.

In a field of image processing, contour correction techniques for increasing a slope of a contour, enhancing fineness and sharpness of an image and improving image quality have been widely known. Examples of the contour correction techniques include “shoot enhancement” for adding preshoot or overshoot on the basis of a high-frequency component, increasing the slope of the contour, increasing the contrast difference, and enhancing sharpness and “shootless enhancement” for increasing the slope of the contour without adding the preshoot or the overshoot and enhancing sharpness.

If shoot enhancement processing is executed with respect to an image, the contrast difference increases and the sharpness is enhanced. However, there occurs a side effect, for example, shoot is viewed as if the shoot has been bordered, which results in deteriorating the image quality. Meanwhile, if shootless enhancement processing is executed with respect to the image, the deterioration in the image quality due to the shoot does not occur. However, the contrast difference does not increase and the sharpness is insufficient.

For example, an image display apparatus that determines a synthesis ratio of a correction signal subjected to the shoot enhancement processing and a correction signal subjected to the shootless enhancement processing, on the basis of a contour feature amount of an attention pixel, synthesizes the correction signals, suppresses a side effect of bordering in a contour portion, and obtains sufficient sharpness with respect to a fine texture portion corresponding to a background has been suggested (for example, refer to Japanese Patent Application Publication No. 2006-106921).

Each enhancement circuit of the image display apparatus is configured to execute the enhancement processing with respect to the contour of an input signal. In this case, the shoot enhancement processing corresponds to processing for adjusting a high-band large amplitude component of an image signal and the shootless enhancement processing corresponds to processing for adjusting a high-band small amplitude component of the image signal. When there is thin overshoot in the input image, the overshoot can be adjusted by decreasing the enhancement by the shoot enhancement processing. However, the enhancement processing is invalid with respect to thick overshoot.

Meanwhile, in contents such as movies provided by large-capacity media such as Blu-ray disks, unnatural contents where the thick contour is sharp are discovered in places. This is considered as follows. When the contents are recorded in the media, it is anticipated that the contents become an image having small noise, image processing for enhancing an intermediate-band large amplitude component is executed. As a result, the overshoot is added.

FIG. 13A shows an example of an input image including overshoot. FIG. 13B shows a brightness change of one horizontal line of the input image shown in FIG. 13A. In FIG. 13B, a horizontal axis indicates horizontal coordinates of a pixel and a vertical axis indicates brightness. Referring to FIG. 13A, the overshoot along the contour is obvious. This is because an intermediate-band large amplitude component is excessively enhanced, as can be known by referring to approximately an intermediate band of FIG. 13A. A texture portion on the right side of the contour corresponds to a high-band small amplitude component, as can be known from FIG. 13A.

The overshoot thick along the contour as shown in FIG. 13A does not exist originally in an original image (film movie) before image processing when the image is recorded in the media and causes artificial image quality. Referring to the texture portion, there is no sharpness.

Basically, the image processing apparatus executes the shoot enhancement processing with respect to a high-band large amplitude component and executes the shootless enhancement processing with respect to a high-band small amplitude component. However, the image processing apparatus may not remove the thick overshoot that corresponds to an intermediate-band large amplitude component.

### SUMMARY

Accordingly, it is desirable to provide an image processing apparatus, an image processing method, and a computer program that can perform contour correction with respect to an input image such as a movie and enhance fineness and sharpness.

In addition, it is desirable to provide an image processing apparatus, an image processing method, and a computer program that can suppress overshoot of a thick contour included in an input image such as a movie and enhance fineness.

According to an embodiment of the present disclosure, there is provided an image processing apparatus including an image input unit that inputs an image, a high bandpass filter that extracts a high-band component of the input image, a high-band small amplitude extracting unit that extracts a small amplitude component from the high-band component extracted by the high bandpass filter, a high-band small amplitude adjusting unit that adjust a high-band small amplitude component extracted by the high-band small amplitude extracting unit, an intermediate bandpass filter that extracts an intermediate-band component of the input image, an intermediate-band large amplitude extracting unit that extracts a large amplitude component from the intermediate component extracted by the intermediate bandpass filter, an intermediate-band large amplitude adjusting unit that adjusts an intermediate-band large amplitude component extracted by the intermediate-band large amplitude extracting unit, and an adding unit that adds the high-band small amplitude component adjusted by the high-band small amplitude adjusting unit and the intermediate-band large amplitude component adjusted by the intermediate-band large amplitude adjusting unit to the input image.

The image processing apparatus may further include an interlocking unit that controls the adjustment of the high-band small amplitude component performed by the high-band small amplitude adjusting unit to be interlocked with the adjustment of the intermediate-band large amplitude component performed by the intermediate-band large amplitude adjusting unit.

The image processing apparatus may further include a high-band large amplitude extracting unit that extracts a large amplitude component from the high-band component extracted by the high bandpass filter, a high-band large amplitude adjusting unit that adjusts a high-band large amplitude component extracted by the high-band large amplitude extracting unit, an intermediate-band small amplitude extracting unit that extracts a small amplitude component from the intermediate-band component extracted by the intermediate bandpass filter, and an intermediate-band small amplitude adjusting unit that adjusts an intermediate-band small amplitude component extracted by the intermediate-band small amplitude extracting unit. The adding unit adds the high-band large amplitude component adjusted by the high-band large amplitude adjusting unit, the high-band small amplitude component adjusted by the high-band small amplitude adjusting unit, the intermediate-band large amplitude component adjusted by the intermediate-band large amplitude adjusting unit, and the intermediate-band small amplitude component adjusted by the intermediate-band small amplitude adjusting unit to the input image.

The image processing apparatus may further include an interlocking unit that controls the adjustment of the high-band small amplitude component performed by the high-band small amplitude adjusting unit to be interlocked with the adjustment of the intermediate-band large amplitude component performed by the intermediate-band large amplitude adjusting unit.

Frequency bands extracted by the high bandpass filter and the intermediate bandpass filter may be determined in cooperation with the number of pixels of the image input by the image input unit and the number of pixels when an image output from the adding unit is displayed.

According to another embodiment of the present disclosure, there is provided an image processing method including inputting an image, extracting an intermediate-band component of the input image, extracting a large amplitude component from the intermediate-band component extracted in the intermediate-band extracting step, adjusting an intermediate-band large amplitude component extracted in the intermediate-band large amplitude extracting step, extracting a high-band component of the input image, extracting a small amplitude component from the high-band component extracted in the high-band extracting step, adjusting the high-band small amplitude component extracted in the high-band small amplitude extracting step to be interlocked with the adjustment of the intermediate-band large amplitude component performed in the intermediate-band large amplitude adjusting step, and adding the high-band small amplitude component adjusted in the high-band small amplitude adjusting step and the intermediate-band large amplitude component adjusted in the intermediate-band large amplitude adjusting step to the input image.

According to another embodiment of the present disclosure, there is provided a computer program written in a computer readable format, the computer program causing a computer to function as an image input unit that inputs an image, an intermediate-band extracting unit that extracts an intermediate-band component of the input image, an intermediate-band large amplitude extracting unit that extracts a large amplitude component from the intermediate-band component extracted by the intermediate-band extracting unit, an intermediate-band large amplitude adjusting unit that adjusts an intermediate-band large amplitude component extracted by the intermediate-band large amplitude extracting unit, a high-band extracting unit that extracts a high-band component of the input image, a high-band small amplitude extracting unit that extracts a small amplitude component from the high-band component extracted by the high-band extracting unit, a high-band small amplitude adjusting unit that adjusts the high-band small amplitude component extracted by the high-band small amplitude extracting unit to be interlocked with the adjustment of the intermediate-band large amplitude component performed by the intermediate-band large amplitude adjusting unit, and an adding unit that adds the high-band small amplitude component adjusted by the high-band small amplitude adjusting unit and the intermediate-band large amplitude component adjusted by the intermediate-band large amplitude adjusting unit to the input image.

According to the embodiment of the present disclosure described above, the computer program may be a computer program described with a computer readable format to realize predetermined processing on a computer. That is, if the computer program is installed in the computer, a cooperative function is shown on the computer and the same function and effect as those of the image processing apparatus can be obtained.

According to the embodiments of the present disclosure described above, an image processing apparatus, an image processing method, and a computer program that can suppress overshoot of a thick contour included in an input image such as a movie and enhance fineness can be provided.

According to the embodiments of the present disclosure described above, a high-band small amplitude component is extracted from an input image and is enhanced to be interlocked with extraction of an intermediate-band large amplitude component from the input image and attenuation of thick overshoot. Therefore, an unnatural input image in which a thick contour is sharp can be corrected with a natural high-resolution image in which fineness is enhanced.

Other objects, features, and advantages of the present disclosure will be more apparent from the following description taken in conjunction with the embodiments and the accompanying drawings.

### BRIEF DESCRIPTION OF THE DRAWINGS

FIG. 1 is a diagram showing a relative amplitude change when processing for suppressing thick overshoot and enhancing a high band having small amplitude is executed with respect to an input image shown in FIG. 13;

FIG. 2A is a diagram showing an image after processing for suppressing thick overshoot and enhancing a high band having small amplitude is executed with respect to an input image shown in FIG. 13;

FIG. 2B is a diagram showing a brightness change of one horizontal line of an input image shown in FIG. 2A;

FIG. 3A is a diagram showing an example of a configuration of an image display apparatus 300 to which the present disclosure is applicable;

FIG. 3B is a diagram showing an example of a configuration of an image reproducing apparatus 350 to which the present disclosure is applicable;

FIG. 4 is a diagram showing an example of an internal configuration of a video processing circuit 304;

FIG. 5 is a diagram showing an example of a configuration of an enhancement circuit 403;

FIG. 6 is a diagram showing an example of a configuration of a GUI screen when enhancement gains of high-band small amplitude and intermediate-band large amplitude are adjusted;

FIG. 7 is a diagram showing another example of a configuration of the enhancement circuit 403;

FIG. 8 is a diagram showing an example of a configuration of a GUI screen when enhancement gains of high-band small amplitude and intermediate-band large amplitude are adjusted;

FIG. 9 is a diagram showing another example of a configuration of the enhancement circuit 403;

FIG. 10 is a diagram showing an example of a configuration of a GUI screen when enhancement gains of high-band large amplitude, high-band small amplitude, intermediate-band large amplitude, and intermediate-band small amplitude are adjusted;

FIG. 11 is a diagram showing another example of a configuration of the enhancement circuit 403;

FIG. 12 is a diagram showing an example of a configuration of a GUI screen when enhancement gains of high-band large amplitude, high-band small amplitude, intermediate-band large amplitude, and intermediate-band small amplitude are adjusted;

FIG. 13A is a diagram showing an example of an input image including overshoot;

FIG. 13B is a diagram showing a brightness change of one horizontal line of an input image shown in FIG. 13A;

FIG. 14 is a diagram showing a change of relative amplitude according to a frequency after a low frequency is set to 1, with respect to an input image shown in FIG. 13A;

FIG. 15 is a diagram showing a change of relative amplitude after processing for suppressing thick overshoot is executed with respect to an input image shown in FIG. 13A;

FIG. 16A is a diagram showing an image after processing for suppressing thick overshoot is executed with respect to an input image shown in FIG. 13A; and

FIG. 16B is a diagram showing a brightness change of one horizontal line of an input image shown in FIG. 16A.

### DETAILED DESCRIPTION OF THE EMBODIMENT(S)

Hereinafter, preferred embodiments of the present disclosure will be described in detail with reference to the appended drawings.

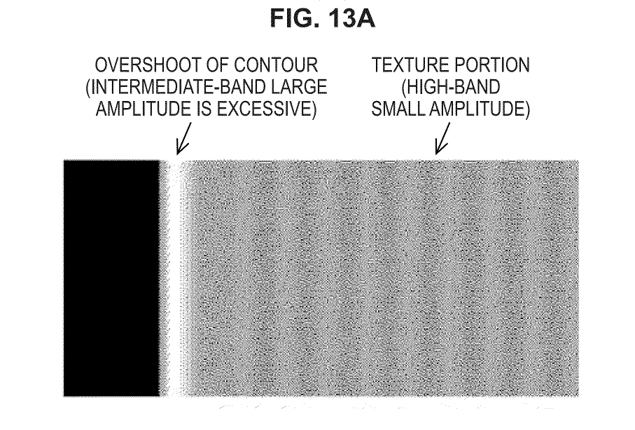

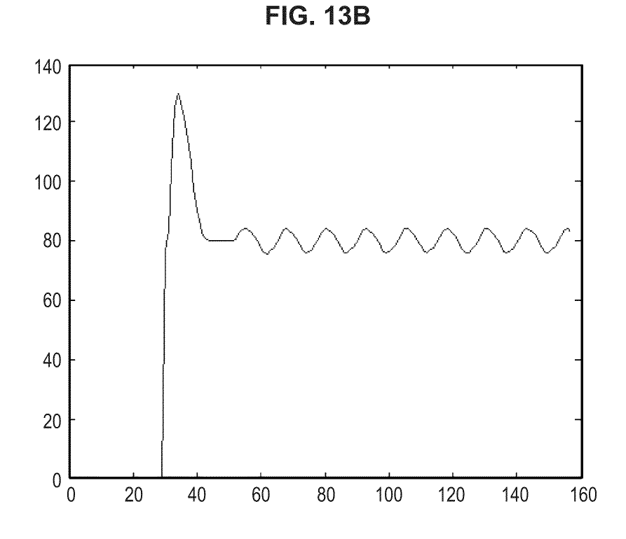

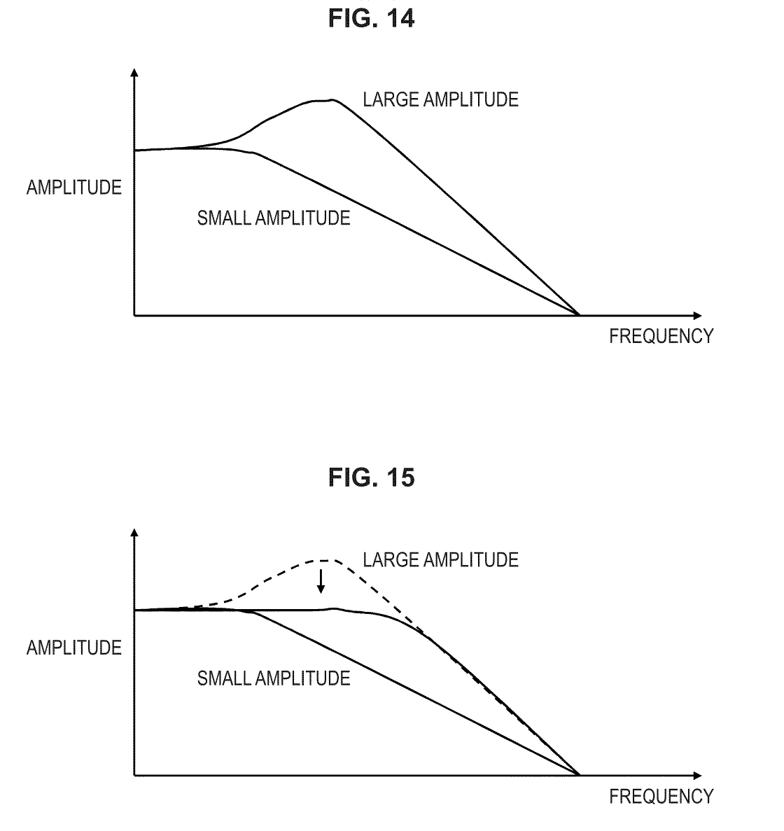

The technical problem that is described in “BACKGROUND” is further considered. FIG. 14 shows a change of relative amplitude according to a frequency after a low frequency is set to 1, with respect to an unnatural image shown in FIG. 13. Overshoot thick along a contour becomes large amplitude in an intermediate band. As described above, the overshoot thick along the contour does not exist originally in an original image (film movie) before image processing when the image is recorded in the media and causes artificial image quality. Meanwhile, amplitude of a texture portion moderately decreases when a band becomes high. That is, because minute amplitude is not extended, there is no sharpness in the texture portion.

As one method of resolving the above-described problem, a method of extracting a large amplitude component of an intermediate band from an input image and suppressing only thick overshoot is considered. A relative amplitude change after processing for suppressing the thick overshoot is executed with respect to an input image shown in FIG. 13A is shown in FIG. 15. Referring to FIG. 15, it can be seen that large amplitude (shown by a dotted line) in an intermediate band is suppressed. However, a small amplitude component of a high band is maintained as it is. Therefore, if only the overshoot is lowered, only image quality in which the contour becomes dim is obtained and an observer may not sense that the image quality is improved.

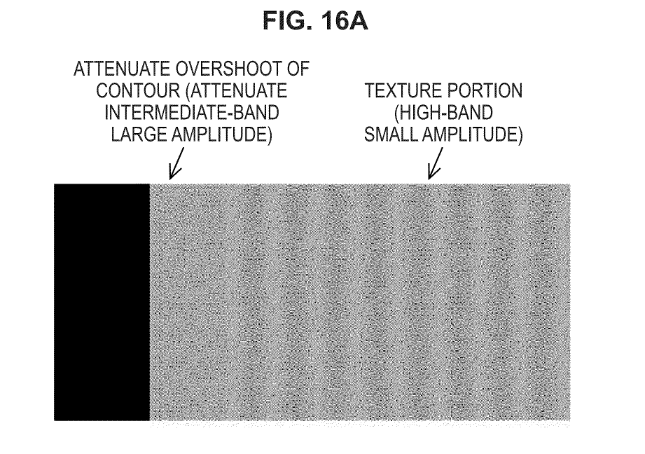

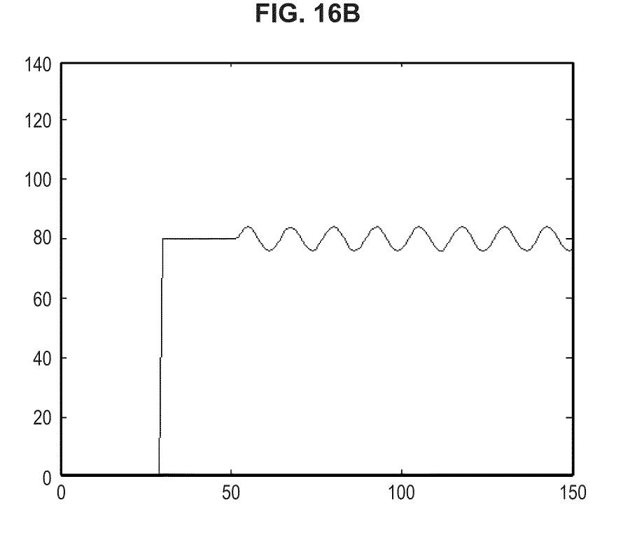

FIG. 16A shows an image after processing for suppressing thick overshoot is executed with respect to the input image shown in FIG. 13. FIG. 16B shows a brightness change of one horizontal line of the input image shown in FIG. 16A. In FIG. 16B, a horizontal axis indicates horizontal coordinates of a pixel and a vertical axis indicates brightness. Referring to FIG. 16A, the overshoot thick along the contour is attenuated. Referring to approximately an intermediate band of FIG. 16A, the large amplitude component of approximately the intermediate band shown in FIG. 13A is attenuated. However, referring to approximately a high band of FIG. 16A, a small amplitude component is maintained at it is. Referring to a texture portion of FIG. 16A, there is no sharpness. That is, if only the overshoot is lowered, only image quality in which the contour becomes dim is obtained and an observer may not sense that the image quality is improved.

Therefore, in the present disclosure, technology for extracting a small amplitude component of a high band from an input image and enhancing the small amplitude component to be interlocked with processing for extracting a large amplitude component of an intermediate band from the input image and attenuating thick overshoot is suggested. If the high band having small amplitude is enhanced, fineness is enhanced and natural high-resolution video can be obtained.

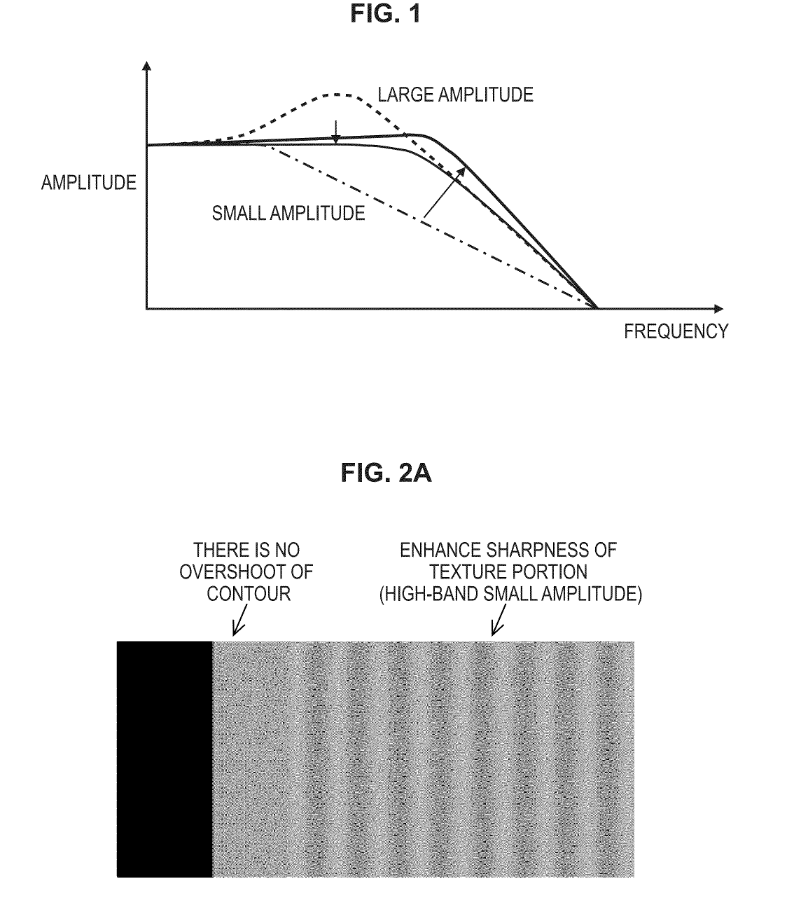

FIG. 1 shows a relative amplitude change when processing for suppressing thick overshoot and enhancing a high band having small amplitude is executed with respect to the input image shown in FIG. 13A. As shown in FIG. 1, a large amplitude (shown by a dotted line) in an intermediate band is suppressed and a small amplitude component (shown by a one-dot chained line) of the high band is enhanced. As a result, the high band having small amplitude is enhanced, fineness is enhanced, and natural high-resolution video is obtained.

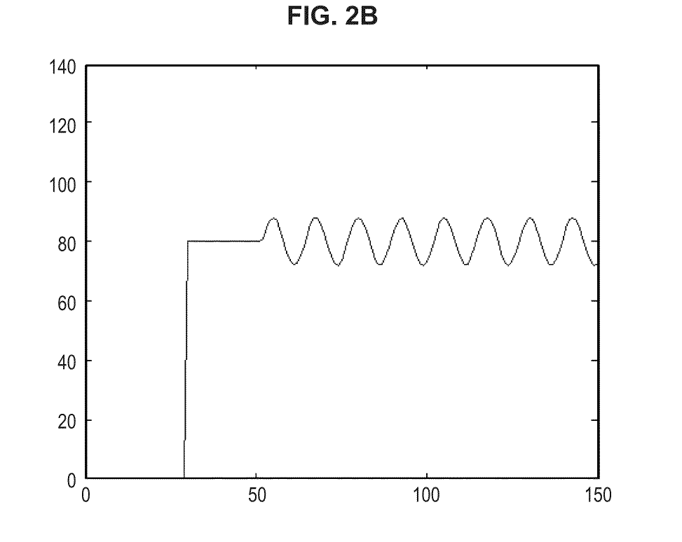

FIG. 2A shows an image after processing for suppressing thick overshoot and enhancing a high band having small amplitude is executed with respect to the input image shown in FIG. 13A. FIG. 2B shows a brightness change of one horizontal line of the input image shown in FIG. 2A. In FIG. 2B, a horizontal axis indicates horizontal coordinates of a pixel and a vertical axis indicates brightness. Referring to FIG. 2A, the overshoot thick along the contour disappears. Referring to approximately an intermediate band of FIG. 2A, the large amplitude component of approximately the intermediate band shown in FIG. 13A is attenuated. Meanwhile, referring to approximately a high band of FIG. 2A, a small amplitude component is amplified. Referring to a texture portion of FIG. 2A, it can be seen that sharpness is enhanced. That is, if the high band having the small amplitude is enhanced, fineness is enhanced and natural high-resolution video is obtained.

When the overshoot thick along the contour in an input image bothers a user, processing for attenuating a large amplitude component of an intermediate band of an image signal is executed. However, processing for enhancing a high-band small amplitude component is preferably executed to be interlocked with the above processing, as shown in FIGS. 1 and 2B.

The image processing may be automatically executed in the image display apparatus. However, the image display apparatus may be configured such that the user can perform adjustment manually.

In the case of the latter, when the overshoot thick along the contour in the display image bothers the user, the user performs the adjustment of the intermediate-band large amplitude component manually, such that the overshoot disappears and natural high-resolution video is obtained. If control of the high-band small amplitude component is interlocked with the adjustment of the intermediate-band large amplitude component, as shown in FIGS. 1 and 2B, the high-band small amplitude component is automatically enhanced according to the attenuation of the intermediate-band large amplitude component. As a result, fineness of the texture portion is enhanced and natural high-resolution video is obtained. Therefore, if only the overshoot thick along the contour bothers the user and the user adjusts the image quality, natural high-resolution video in which fineness of the texture portion is enhanced can be automatically obtained, even if the user is not conscious of the high-band small amplitude component, that is, the fineness of the texture portion.

Basically, when gain of the intermediate-band large amplitude component is decreased, gain of the high-band small amplitude component is increased to be interlocked with the decrease in the gain of the intermediate-band large amplitude component. In contrast, when the gain of the intermediate-band large amplitude component is increased, the gain of the high-band small amplitude component is decreased. An example of an adjustment amount of the gain of the intermediate-band large amplitude component and an adjustment amount of the gain of the high-band small amplitude component interlocked with the adjustment amount of the gain of the intermediate-band large amplitude component is shown in the following table 1. When the gain of the intermediate-band large amplitude component is increased and the overshoot thick along the contour is emphasized, the intermediate-band large amplitude component may not be adjusted. Therefore, the interlocked adjustment amount becomes 0.

TABLE 1

| Intermediate-band large | Interlocked high-band small |
|---|---|
| amplitude (dB) | amplitude (dB) |
| 3 | 0 |
| 2 | 0 |
| 1 | 0 |
| 0 | 0 |
| −1 | 1 |
| −2 | 2 |
| −3 | 3 |

Meanwhile, if the control of the high-band small amplitude component is not interlocked with the adjustment of the intermediate-band large amplitude component, image quality in which the texture portion is not sharp and a link becomes dim is obtained, as long as the user controls the high-band small amplitude component. Therefore, the user may not sense that the image quality is improved.

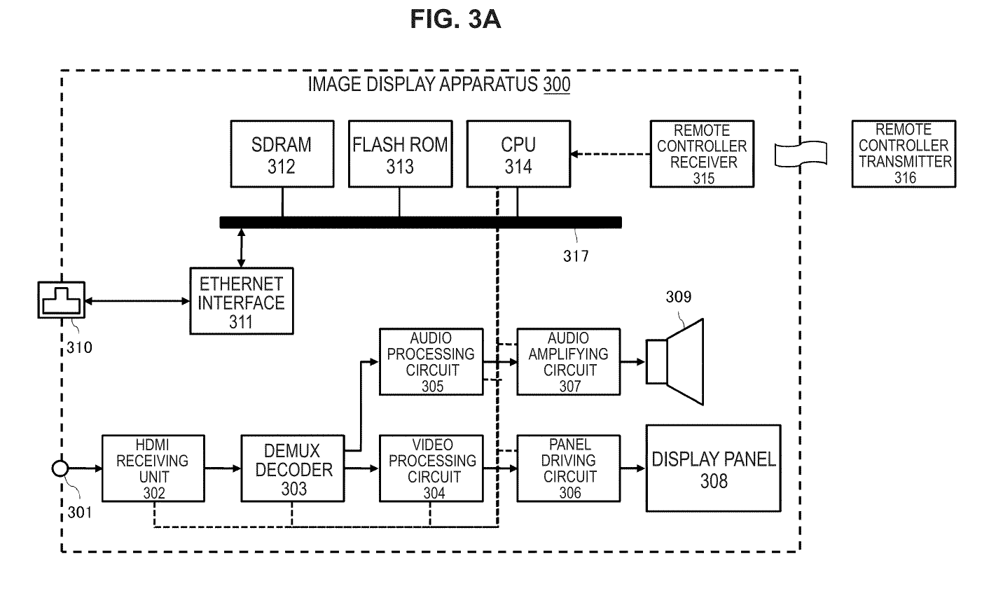

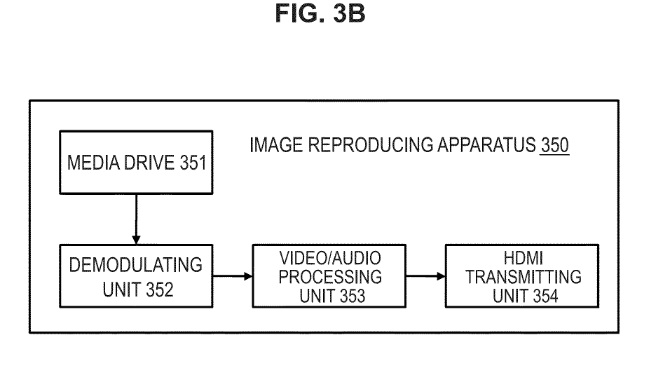

FIG. 3A shows an example of a configuration of an image display apparatus 300 to which enhancement processing according to the present disclosure is applicable. The image display apparatus 300 shown in FIG. 3A uses a content server (not shown in the drawings) disposed on a broadband network such as the Internet or an image reproducing apparatus (not shown in the drawings) such as a Blu-ray disk player as a source of a display image.

The image reproducing apparatus not shown in the drawings is connected to a high definition multimedia interface (HDMI) terminal. An HDMI receiving unit 302 executes processing such as waveform equalization or digital conversion of a baseband signal received through an HDMI cable.

A demultiplexer (DEMUX) 303 demultiplexes video data and audio data from the baseband signal obtained by the HDMI receiving unit 302.

A video processing circuit 304 executes processing such as removing of dot interference and cross color interference, interlace/progressive (IP) conversion, scaling, enhancement, and overlapping of graphic data such as on screen display (OSD), with respect to the video data obtained by the demultiplexer 303.

A panel driving circuit 306 drives a display panel 308 on the basis of video data output from the video processing circuit 304. The display panel 308 is configured using a liquid crystal display (LCD) or a plasma display panel (PDP). An audio processing circuit 305 executes necessary processing such as sound quality adjustment processing or D/A conversion processing, with respect to the audio data obtained by the demultiplexer 303. An audio amplifying circuit 307 amplifies an audio signal output from the audio processing circuit 305 and supplies the audio signal to a speaker 309.

A central processing unit (CPU) 314, a flash read only memory (ROM) 313, a synchronous dynamic random memory (SDRAM) 312, and an Ethernet (registered trademark) interface 311 are connected to an internal bus 317.

An Ethernet (registered trademark) cable is connected to a network terminal 310. The network terminal 310 is connected to the Ethernet (registered trademark) interface 311 through the Ethernet cable. The Ethernet (registered trademark) interface 311 executes processing for receiving PES packets of video and audio data transmitted with a PS format, such as waveform equalization or digital conversion of a signal received through the Ethernet (registered trademark) cable. The PES packets of the video data and the PES packets of the audio data are decoded by an MPEG decoder 303.

The CPU 314 controls an operation of each unit in the image display apparatus 300. The flash ROM 313 stores control software and stores data in a nonvolatile manner. The SDRAM 312 forms a work area of the CPU 314. The CPU 314 develops software or data read from the flash ROM 313 to the SDRAM 312, starts control software, and controls each unit in the image display apparatus 300.

A remote controller receiver 315 receives a remote control signal (remote control code) transmitted from a remote controller transmitter 316 and supplies the remote control signal to the CPU 314. The CPU 314 controls each unit in the image display apparatus 300, on the basis of the received remote control code.

As processing instructed by the remote control code from the remote controller transmitter 316, reproduction of video and audio, a stop operation, and image quality adjustment processing of output video in the display panel 308 are exemplified.

FIG. 3B shows an example of a configuration in the case in which enhancement processing according to the present disclosure is applied to an image reproducing apparatus 350.

A media drive 351 reads packetized elementary stream (PES) packets of video and audio data with a program stream (PS) format, from recording surfaces of recording media (not shown in the drawings) such as Blu-ray discs. A demodulating unit 352 demodulates the read data and obtains video and audio signals. A video/audio processing unit 353 executes predetermined signal processing with respect to the video and audio signals. As the signal processing executed with respect to the video signal, the same enhancement processing as the enhancement processing that is executed in the video processing circuit 304 is exemplified. Video and audio baseband signals after the signal processing are output from an HDMI transmitting unit 354 to a display apparatus (not shown in the drawings) through the HDMI cable.

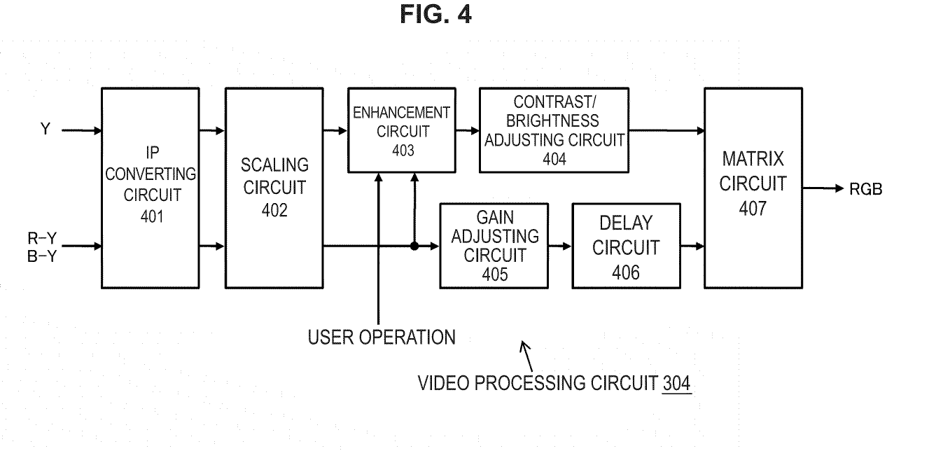

FIG. 4 shows an example of an internal configuration of the video processing circuit 304. The video processing circuit 304 shown in FIG. 4 includes an IP converting circuit 401, a scaling circuit 402, an enhancement circuit 403, a contrast/brightness adjusting circuit 404, a gain adjusting circuit 405, a delay circuit 406, and a matrix circuit 407.

The IP converting circuit 401 converts brightness data (brightness signal) Y and color-difference data (color signals) R-Y and B-Y output from the MPEG decoder 303, from interlace signals to progressive signals. The scaling circuit 402 executes scaling processing to implement resolution suitable for displaying data on a display panel 308, with respect to the brightness data Y and the color-difference data R-Y and B-Y output from the IP converting circuit 401. Ideally, the scaling circuit 402 is preferably disposed right in front of the matrix circuit 307 to be described below, in terms of performance.

The enhancement circuit 403 executes enhancement processing for enhancing sharpness of video, with respect to the brightness data Y output from the scaling circuit 402. The enhancement circuit 403 adjusts enhancement/gain of each pixel. The technology for performing the shoot enhancement and the shootless enhancement with respect to the high-band component of the brightness data is already known (for example, refer to Japanese Patent Application Publication No. 2006-106921). The technology disclosed in the present disclosure is to mainly execute the enhancement processing with respect to the intermediate-band component and interlock the control of the high-band small amplitude component with the adjustment of the intermediate-band large amplitude component. The enhancement circuit 403 is described in detail below.

The contrast/brightness adjusting circuit 404 executes processing for adjusting the contrast/brightness with respect to the brightness data Y output from the enhancement circuit 403, on the basis of an operation from a user. The gain adjusting circuit 405 executes processing for adjusting gain with respect to the color-difference data R-Y and B-Y output from the scaling circuit 402, on the basis of an operation from a user. The delay circuit 406 executes delay processing for matching timing with the brightness data Y, with respect to the color-difference data R-Y and B-Y output from the gain adjusting circuit 405.

The matrix circuit 407 executes matrix processing with respect to the brightness data Y output from the contrast/brightness adjusting circuit 404 and the color-difference data R-Y and B-Y output from the delay circuit 136 and outputs three primary color data RGB of red, green, and blue. The three primary color data RGB is supplied to a panel driving circuit 306 at a rear stage of the video processing circuit 304.

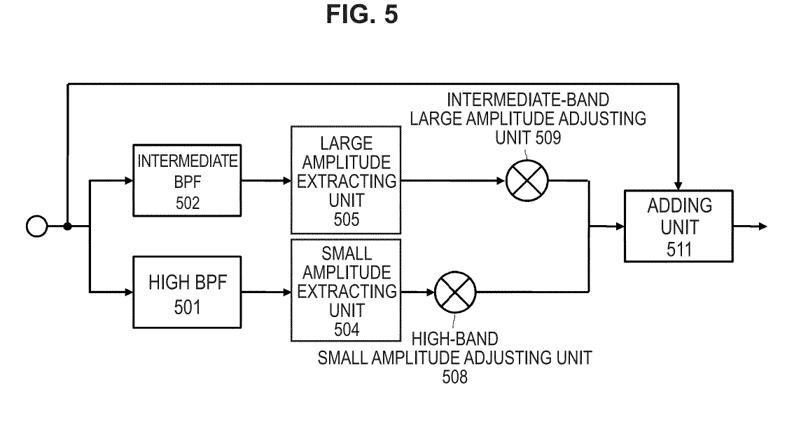

FIG. 5 shows an example of a configuration of an enhancement circuit 403.

A high bandpass filter (BPF) 501 extracts a high-band component from an input signal. A small amplitude extracting unit 504 extracts a high-band small amplitude component from an output of the high bandpass filter 501. A high-band small amplitude adjusting unit 508 adjusts a signal level of the extracted high-band small amplitude component.

An intermediate bandpass filter (BPF) 502 extracts an intermediate-band component from the input signal. A large amplitude extracting unit 505 extracts an intermediate-band large amplitude component from an output of the intermediate bandpass filter 502. An intermediate-band large amplitude adjusting unit 509 adjusts a signal level of the extracted intermediate-band large amplitude component.

An adding unit 511 adds the high-band small amplitude component adjusted by the high-band small amplitude adjusting unit 508 and the intermediate-band large amplitude component adjusted by the intermediate-band large amplitude adjusting unit 509 to the input image.

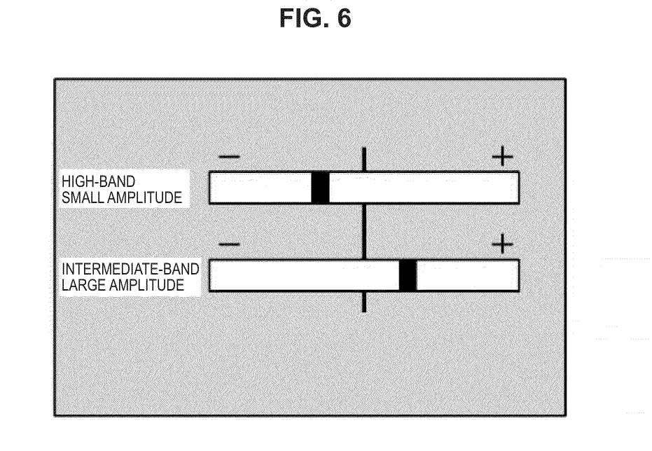

The gains of the high-band small amplitude adjusting unit 508 and the intermediate-band large amplitude adjusting unit 509 can be adjusted by an operation from the user. In this case, the operation from the user may be an operation that is performed by the user with respect to a display screen of the display panel 308, using the remote controller transmitter 316. FIG. 6 shows an example of a configuration of a graphical user interface (GUI) screen when enhancement gains of high-band small amplitude and intermediate-band large amplitude are adjusted. On a screen shown in FIG. 6, scales that show gain levels of the high-band small amplitude and the intermediate-band large amplitude are displayed. If the user instructs to adjust the gain level of each component using the remote controller transmitter 316, display of the scales changes up and down in response to the instruction.

For example, when the overshoot thick along the contour in the display image bothers the user, the user performs the adjustment of the intermediate-band large amplitude component using the remote controller transmitter 316, such that the overshoot disappears and natural high-resolution video is obtained. At this time, preferably, the high-band small amplitude component is enhanced according to the attenuation of the intermediate-band large amplitude component. As a result, fineness of the texture portion is enhanced and natural high-resolution video is obtained.

However, when the user who is poor at an operation or lacks video technology adjusts the intermediate-band large amplitude component and removes the overshoot thick along the contour, the user may forget that the high-band small amplitude component is preferably enhanced. As a result, image quality in which the texture portion is not sharp and a link becomes dim is obtained and the user may not sense that the image quality is improved.

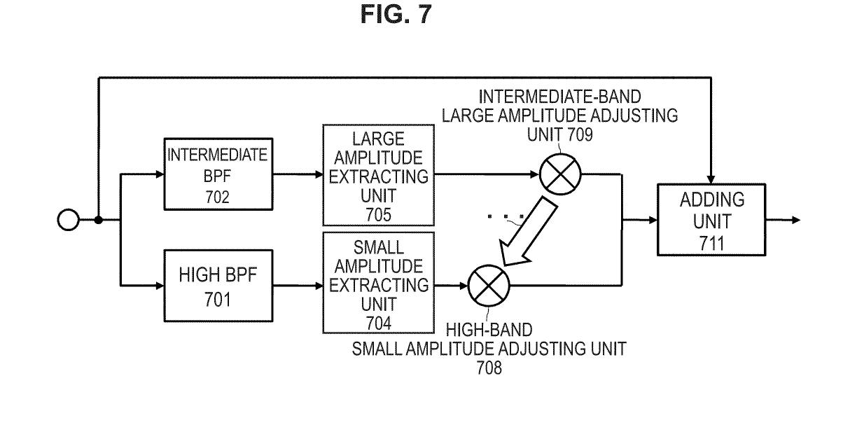

FIG. 7 shows another example of a configuration of the enhancement circuit 403.

A high bandpass filter (BPF) 701 extracts a high-band component from an input signal. A small amplitude extracting unit 704 extracts a high-band small amplitude component from an output of the high bandpass filter 701. A high-band small amplitude adjusting unit 708 adjusts a signal level of the extracted high-band small amplitude component.

An intermediate bandpass filter (BPF) 702 extracts an intermediate-band component from the input signal. A large amplitude extracting unit 705 extracts an intermediate-band large amplitude component from an output of the intermediate bandpass filter 702. An intermediate-band large amplitude adjusting unit 709 adjusts a signal level of the extracted intermediate-band large amplitude component.

An adding unit 711 adds the high-band small amplitude component adjusted by the high-band small amplitude adjusting unit 708 and the intermediate-band large amplitude component adjusted by the intermediate-band large amplitude adjusting unit 709 to the input image.

The gains of the high-band small amplitude adjusting unit 708 and the intermediate-band large amplitude adjusting unit 709 can be adjusted by the operation from the user. In this case, the operation from the user may be an operation that is performed by the user with respect to the display screen of the display panel 308, using the remote controller transmitter 316. However, the configuration example shown in FIG. 7 is different from the configuration example shown in FIG. 5 in that an interlocking unit 712 is provided to interlock the gain adjustment amount in the high-band small amplitude adjusting unit 708 with the gain adjustment amount in the intermediate-band large amplitude adjusting unit 709. The interlocking unit 712 is simplified in FIG. 7. However, in actuality, the interlocking unit 712 is a circuit of a high-band side that is interlocked with the intermediate-band large amplitude adjusting unit 709. Basically, when the gain of the intermediate-band large amplitude component is decreased, the interlocking unit 712 increases the gain of the high-band small amplitude component to be interlocked with the decrease in the gain of the intermediate-band large amplitude component. In contrast, when the gain of the intermediate-band large amplitude component is increased, the interlocking unit 712 decreases the gain of the high-band small amplitude component. The gain adjustment amount of the high-band small amplitude component is interlocked with the gain adjustment amount of the intermediate-band large amplitude component, as shown in the table 1. If the intermediate-band large amplitude component is adjusted, it may become difficult for the user to read subtitles. In order to resolve this problem, an interlocking unit (not shown in the drawings) that controls the high-band large amplitude adjusting unit 707 to be interlocked with the intermediate-band large amplitude adjusting unit 709 may be further provided.

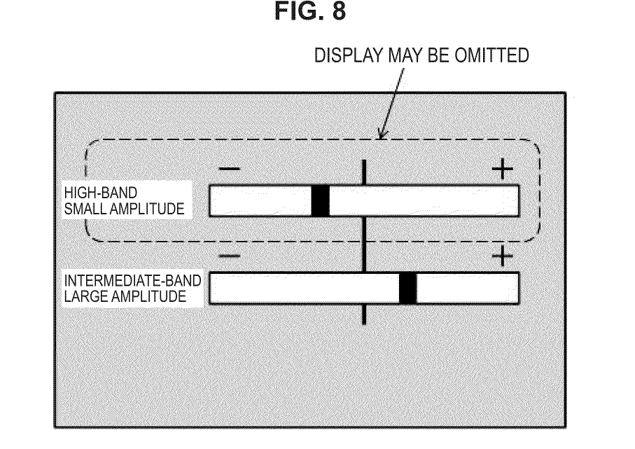

FIG. 8 shows an example of a configuration of a GUI screen when enhancement gains of high-band small amplitude and intermediate-band large amplitude are adjusted. On a screen shown in FIG. 8, scales that show gain levels of the high-band small amplitude and the intermediate-band large amplitude are displayed. If the user instructs to adjust the gain level of each component using the remote controller transmitter 316, display of the scales changes up and down in response to the instruction. However, since the gain level of the high-band small amplitude is interlocked with the gain level of the intermediate-band large amplitude, display of the scale for the high-band small amplitude may be omitted.

For example, when the overshoot thick along the contour in the display image bothers the user, the user performs the adjustment of the intermediate-band large amplitude component using the remote controller transmitter 316, such that the overshoot disappears and natural high-resolution video is obtained. In this case, if the control of the high-band small amplitude component is interlocked with the adjustment of the intermediate-band large amplitude component, as shown in FIGS. 1 and 2B, the high-band small amplitude component is enhanced according to the attenuation of the intermediate-band large amplitude component. As a result, fineness of the texture portion is enhanced and natural high-resolution video is obtained. Therefore, if the overshoot thick along the contour bothers the user and the user adjusts the image quality, natural high-resolution video in which fineness of the texture portion is enhanced can be automatically obtained, even if the user is not conscious of the high-band small amplitude component, that is, the fineness of the texture portion.

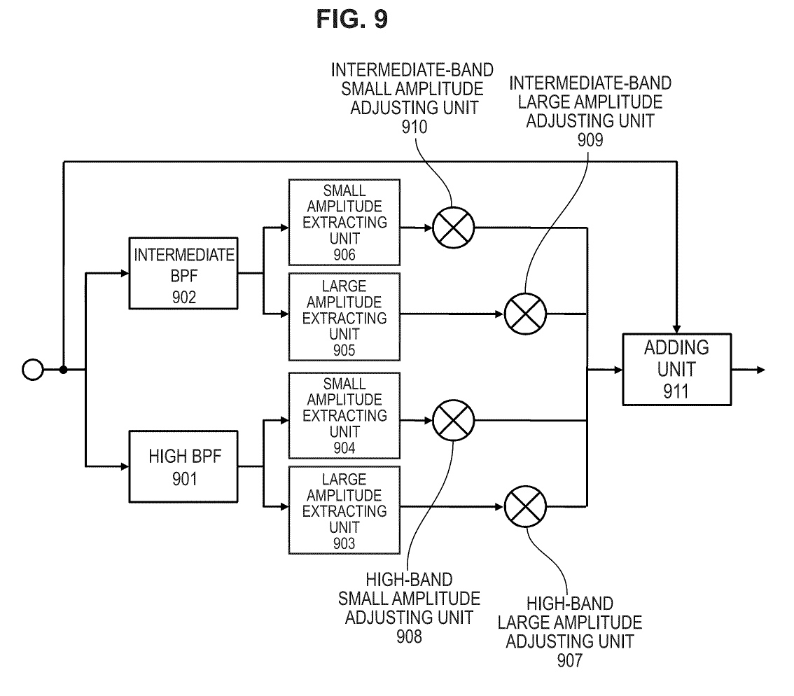

FIG. 9 shows another example of a configuration of the enhancement circuit 403.

A high bandpass filter (BPF) 901 extracts a high-band component from an input signal. A large amplitude extracting unit 903 extracts a high-band large amplitude component from an output of the high bandpass filter 901 and a small amplitude extracting unit 904 extracts a high-band small amplitude component from the output of the high bandpass filter 901. A high-band large amplitude adjusting unit 907 adjusts a signal level of the extracted high-band small amplitude component and a high-band small amplitude adjusting unit 908 adjusts a signal level of the extracted high-band small amplitude component.

An intermediate bandpass filter (BPF) 902 extracts an intermediate-band component from the input signal. A large amplitude extracting unit 905 extracts an intermediate-band large amplitude component from an output of the intermediate bandpass filter 902 and a small amplitude extracting unit 906 extracts an intermediate-band small amplitude component from the output of the intermediate-band bandpass filter 902. An intermediate-band large amplitude adjusting unit 909 adjusts a signal level of the extracted intermediate-band large amplitude component and an intermediate-band small amplitude adjusting unit 910 adjusts a signal level of the extracted intermediate-band small amplitude component.

An adding unit 911 adds the high-band large-amplitude component adjusted by the high-band large amplitude adjusting unit 907, the high-band small amplitude component adjusted by the high-band small amplitude adjusting unit 908, the intermediate-band large amplitude component adjusted by the intermediate-band large amplitude adjusting unit 909, and the intermediate-band small amplitude component adjusted by the intermediate-band small amplitude adjusting unit 910 to the input image.

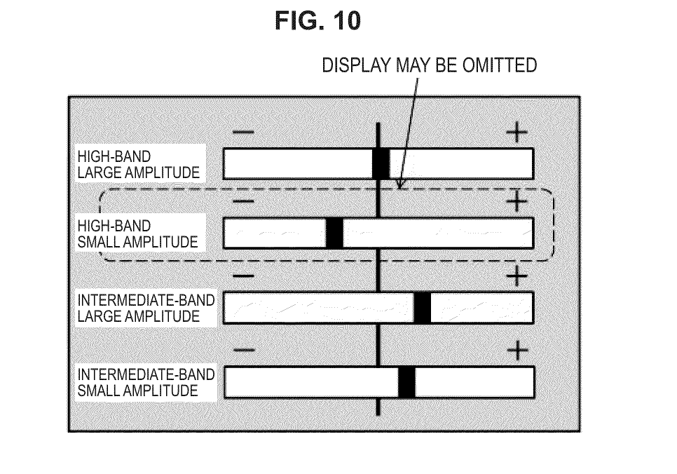

The gains of the high-band large amplitude adjusting unit 907, the high-band small amplitude adjusting unit 908, the intermediate-band large amplitude adjusting unit 909, and the intermediate-band small amplitude adjusting unit 910 can be adjusted by an operation from the user. In this case, the operation from the user may be an operation that is performed by the user with respect to a display screen of the display panel 308, using the remote controller transmitter 316. FIG. 10 shows an example of a configuration of a GUI screen when enhancement gains of high-band large amplitude, high-band small amplitude, intermediate-band large amplitude, and intermediate-band small amplitude are adjusted. On a screen shown in FIG. 10, scales that show gain levels of four kinds of the high-band large amplitude, the high-band small amplitude, the intermediate-band large amplitude, and the intermediate-band small amplitude are displayed. If the user instructs to adjust the gain level of each component using the remote controller transmitter 316, display of the scales changes up and down in response to the instruction.

For example, when the overshoot thick along the contour in the display image bothers the user, the user performs the adjustment of the intermediate-band large amplitude component using the remote controller transmitter 316, such that the overshoot disappears and natural high-resolution video is obtained. At this time, the high-band small amplitude component is preferably enhanced according to the attenuation of the intermediate-band large amplitude component. As a result, fineness of the texture portion is enhanced and natural high-resolution video is obtained.

However, in the configuration example shown in FIG. 9, a mechanism for interlocking the gain adjustment amount in the high-band small amplitude adjusting unit 908 with the gain adjustment amount in the intermediate-band large amplitude adjusting unit 909 is not provided. For this reason, when the user who is poor at an operation or lacks video technology adjusts the intermediate-band large amplitude component and removes the overshoot thick along the contour, the user may forget that the high-band small amplitude component is preferably enhanced. As a result, image quality in which the texture portion is not sharp and a link becomes dim is obtained and the user may not sense that the image quality is improved.

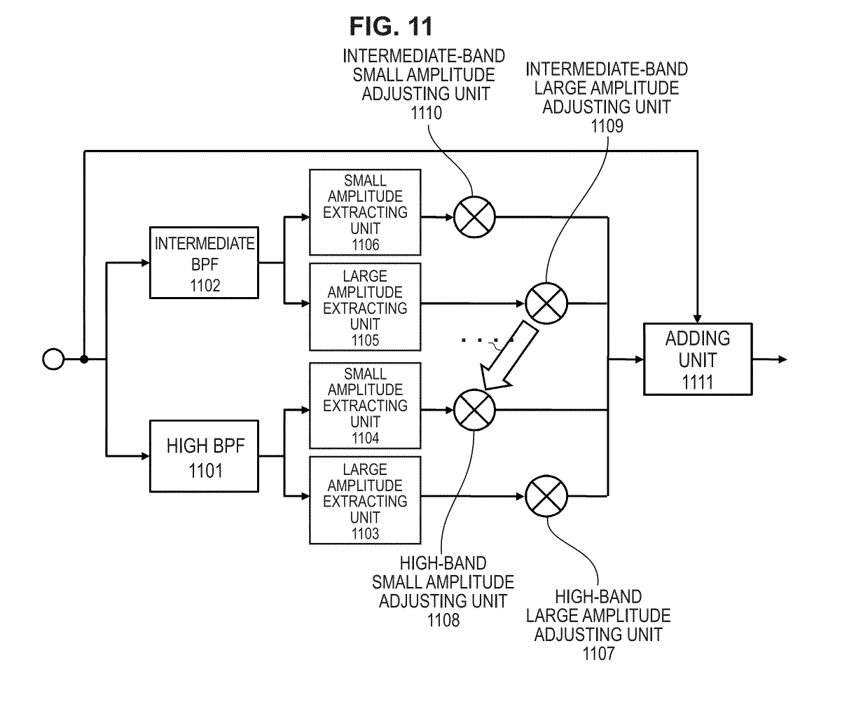

FIG. 11 shows another example of a configuration of the enhancement circuit 403.

A high bandpass filter (BPF) 1101 extracts a high-band component from an input signal. A large amplitude extracting unit 1103 extracts a high-band large amplitude component from an output of the high bandpass filter 1101 and a small amplitude extracting unit 1104 extracts a high-band small amplitude component from the output of the high bandpass filter 1101. A high-band large amplitude adjusting unit 1107 adjusts a signal level of the extracted high-band small amplitude component and a high-band small amplitude adjusting unit 1108 adjusts a signal level of the extracted high-band small amplitude component.

An intermediate bandpass filter (BPF) 1102 extracts an intermediate-band component from the input signal. A large amplitude extracting unit 1105 extracts an intermediate-band large amplitude component from an output of the intermediate bandpass filter 1102 and a small amplitude extracting unit 1106 extracts an intermediate-band small amplitude component from the output of the intermediate-band bandpass filter 1102. An intermediate-band large amplitude adjusting unit 1109 adjusts a signal level of the extracted intermediate-band large amplitude component and an intermediate-band small amplitude adjusting unit 1110 adjusts a signal level of the extracted intermediate-band small amplitude component.

An adding unit 1111 adds the high-band large-amplitude component adjusted by the high-band large amplitude adjusting unit 1107, the high-band small amplitude component adjusted by the high-band small amplitude adjusting unit 1108, the intermediate-band large amplitude component adjusted by the intermediate-band large amplitude adjusting unit 1109, and the intermediate-band small amplitude component adjusted by the intermediate-band small amplitude adjusting unit 1110 to the input image.

The gains of the high-band large amplitude adjusting unit 1107, the high-band small amplitude adjusting unit 1108, the intermediate-band large amplitude adjusting unit 1109, and the intermediate-band small amplitude adjusting unit 1110 can be adjusted by an operation from the user. In this case, the operation from the user may be an operation that is performed by the user with respect to a display screen of the display panel 308, using the remote controller transmitter 316. However, the configuration example shown in FIG. 11 is different from the configuration example shown in FIG. 9 in that an interlocking unit 1112 is provided to interlock the gain adjustment amount in the high-band small amplitude adjusting unit 1108 with the gain adjustment amount in the intermediate-band large amplitude adjusting unit 1109. The interlocking unit 1112 is simplified in FIG. 11. However, in actuality, the interlocking unit 1112 is a circuit of a high-band side that is interlocked with the intermediate-band large amplitude adjusting unit 1109. Basically, when the gain of the intermediate-band large amplitude component is decreased, the interlocking unit 1112 increases the gain of the high-band small amplitude component to be interlocked with the decrease in the gain of the intermediate-band large amplitude component. In contrast, when the gain of the intermediate-band large amplitude component is increased, the interlocking unit 1112 decreases the gain of the high-band small amplitude component. The gain adjustment amount of the high-band small amplitude component is interlocked with the gain adjustment amount of the intermediate-band large amplitude component, as shown in the table 1. If the intermediate-band large amplitude component is adjusted, it may become difficult for the user to read subtitles. In order to resolve this problem, an interlocking unit (not shown in the drawings) that controls the high-band large amplitude adjusting unit 1107 to be interlocked with the intermediate-band large amplitude adjusting unit 1109 may be further provided.

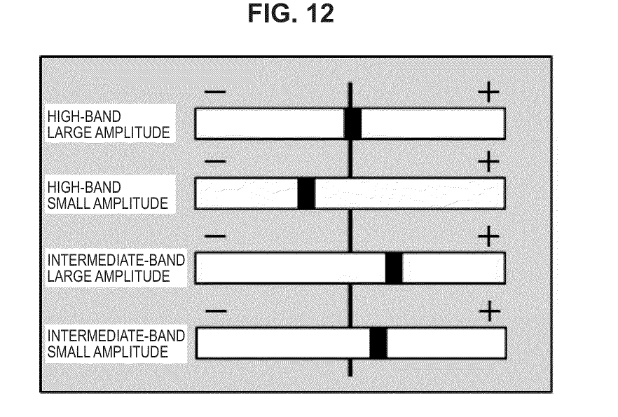

FIG. 12 shows an example of a configuration of a GUI screen when enhancement gains of high-band large amplitude, high-band small amplitude, intermediate-band large amplitude, and intermediate-band small amplitude are adjusted. On a screen shown in FIG. 12, scales that show gain levels of four kinds of the high-band large amplitude, the high-band small amplitude, the intermediate-band large amplitude, and the intermediate-band small amplitude are displayed. If the user instructs to adjust the gain level of each component using the remote controller transmitter 316, display of the scales changes up and down in response to the instruction. However, since the gain level of the high-band small amplitude is interlocked with the gain level of the intermediate-band large amplitude, display of the scale for the high-band small amplitude may be omitted.

The systems of the high-band large amplitude adjusting unit 1107 and the high-band small amplitude adjusting unit 1108 are different from each other and are not interlocked with each other. Therefore, as shown in FIG. 12, on the GUI screen, the high-band large amplitude and the high-band small amplitude are adjusted by operating the individual scales.

In the configuration examples of the enhancement circuit 403 that are shown in FIGS. 5, 7, 9, and 11, the intermediate and high frequency bands are switched in cooperation with an input pixel number and an output pixel number.

In the configuration examples of the enhancement circuit 403 that are shown in FIGS. 9 and 11, the intermediate-band large amplitude and the intermediate-band small amplitude are adjusted because there are two kinds of overshoots and only the large amplitude may be overcorrected or overcorrection may be performed without depending on the amplitude. When there remains the overshoot of the small-band small amplitude after the overshoot of the intermediate-band large amplitude is adjusted, the entire overshoots can be removed by attenuating the intermediate-band small amplitude.

Additionally, the present technology may also be configured as below.

(1) An image processing apparatus including:

an image input unit that inputs an image;

a high bandpass filter that extracts a high-band component of the input image;

a high-band small amplitude extracting unit that extracts a small amplitude component from the high-band component extracted by the high bandpass filter;

a high-band small amplitude adjusting unit that adjust a high-band small amplitude component extracted by the high-band small amplitude extracting unit;

an intermediate bandpass filter that extracts an intermediate-band component of the input image;

an intermediate-band large amplitude extracting unit that extracts a large amplitude component from the intermediate component extracted by the intermediate bandpass filter;

an intermediate-band large amplitude adjusting unit that adjusts an intermediate-band large amplitude component extracted by the intermediate-band large amplitude extracting unit; and

an adding unit that adds the high-band small amplitude component adjusted by the high-band small amplitude adjusting unit and the intermediate-band large amplitude component adjusted by the intermediate-band large amplitude adjusting unit to the input image.

(2) The image processing apparatus according to (1), further including:

an interlocking unit that controls the adjustment of the high-band small amplitude component performed by the high-band small amplitude adjusting unit to be interlocked with the adjustment of the intermediate-band large amplitude component performed by the intermediate-band large amplitude adjusting unit.

(3) The image processing apparatus according to (1), further including:

a high-band large amplitude extracting unit that extracts a large amplitude component from the high-band component extracted by the high bandpass filter;

a high-band large amplitude adjusting unit that adjusts a high-band large amplitude component extracted by the high-band large amplitude extracting unit;

an intermediate-band small amplitude extracting unit that extracts a small amplitude component from the intermediate-band component extracted by the intermediate bandpass filter; and

an intermediate-band small amplitude adjusting unit that adjusts an intermediate-band small amplitude component extracted by the intermediate-band small amplitude extracting unit,

wherein the adding unit adds the high-band large amplitude component adjusted by the high-band large amplitude adjusting unit, the high-band small amplitude component adjusted by the high-band small amplitude adjusting unit, the intermediate-band large amplitude component adjusted by the intermediate-band large amplitude adjusting unit, and the intermediate-band small amplitude component adjusted by the intermediate-band small amplitude adjusting unit to the input image.

(4) The image processing apparatus according to (3), further including:

an interlocking unit that controls the adjustment of the high-band small amplitude component performed by the high-band small amplitude adjusting unit to be interlocked with the adjustment of the intermediate-band large amplitude component performed by the intermediate-band large amplitude adjusting unit.

(5) The image processing apparatus according to any one of (1) to (4),

wherein frequency bands extracted by the high bandpass filter and the intermediate bandpass filter are determined in cooperation with the number of pixels of the image input by the image input unit and the number of pixels when an image output from the adding unit is displayed.

(6) An image processing method including:

inputting an image;

extracting an intermediate-band component of the input image;

extracting a large amplitude component from the intermediate-band component extracted in the intermediate-band extracting step;

adjusting an intermediate-band large amplitude component extracted in the intermediate-band large amplitude extracting step;

extracting a high-band component of the input image;

extracting a small amplitude component from the high-band component extracted in the high-band extracting step;

adjusting the high-band small amplitude component extracted in the high-band small amplitude extracting step to be interlocked with the adjustment of the intermediate-band large amplitude component performed in the intermediate-band large amplitude adjusting step; and

adding the high-band small amplitude component adjusted in the high-band small amplitude adjusting step and the intermediate-band large amplitude component adjusted in the intermediate-band large amplitude adjusting step to the input image.

(7) A computer program written in a computer readable format, the computer program causing a computer to function as:

an image input unit that inputs an image;

an intermediate-band extracting unit that extracts an intermediate-band component of the input image;

an intermediate-band large amplitude extracting unit that extracts a large amplitude component from the intermediate-band component extracted by the intermediate-band extracting unit;

an intermediate-band large amplitude adjusting unit that adjusts an intermediate-band large amplitude component extracted by the intermediate-band large amplitude extracting unit;

a high-band extracting unit that extracts a high-band component of the input image;

a high-band small amplitude extracting unit that extracts a small amplitude component from the high-band component extracted by the high-band extracting unit;

a high-band small amplitude adjusting unit that adjusts the high-band small amplitude component extracted by the high-band small amplitude extracting unit to be interlocked with the adjustment of the intermediate-band large amplitude component performed by the intermediate-band large amplitude adjusting unit; and

an adding unit that adds the high-band small amplitude component adjusted by the high-band small amplitude adjusting unit and the intermediate-band large amplitude component adjusted by the intermediate-band large amplitude adjusting unit to the input image.

The configuration of the present disclosure has been described in detail with reference to the specific embodiments. However, it will be apparent to those skilled in the art that various modifications and substitutions can be made without departing from the scope of the present disclosure.

The present disclosure has been described with reference to the embodiments in which the enhancement processing of the image is executed by the hardware. However, the present disclosure is not limited to the embodiments. For example, the enhancement processing in which the adjustment of the high-band small amplitude component is interlocked with the adjustment of the intermediate-band large amplitude component can be realized by image processing which the CPU 314 executes after starting a predetermined image processing program.

Although the present disclosure has been described in connection with the exemplary embodiments, it should be understood that the contents of the present disclosure are not limitative in all aspects. The scope of the present disclosure is defined by the appended claims.

What is claimed is:

1. An image processing apparatus comprising:
an image input unit that inputs an image;
a high bandpass filter that extracts a high-band component of the input image;
a high-band small amplitude extracting unit that extracts a small amplitude component from the high-band component extracted by the high bandpass filter;
a high-band small amplitude adjusting unit that adjust a high-band small amplitude component extracted by the high-band small amplitude extracting unit;
an intermediate bandpass filter that extracts an intermediate-band component of the input image;
an intermediate-band large amplitude extracting unit that extracts a large amplitude component from the intermediate component extracted by the intermediate bandpass filter;
an intermediate-band large amplitude adjusting unit that adjusts an intermediate-band large amplitude component extracted by the intermediate-band large amplitude extracting unit; and
an adding unit that adds the high-band small amplitude component adjusted by the high-band small amplitude adjusting unit and the intermediate-band large amplitude component adjusted by the intermediate-band large amplitude adjusting unit to the input image.

2. The image processing apparatus according to claim 1, further comprising:
an interlocking unit that controls the adjustment of the high-band small amplitude component performed by the high-band small amplitude adjusting unit to be interlocked with the adjustment of the intermediate-band large amplitude component performed by the intermediate-band large amplitude adjusting unit.

3. The image processing apparatus according to claim 1, further comprising:
a high-band large amplitude extracting unit that extracts a large amplitude component from the high-band component extracted by the high bandpass filter;
a high-band large amplitude adjusting unit that adjusts a high-band large amplitude component extracted by the high-band large amplitude extracting unit;
an intermediate-band small amplitude extracting unit that extracts a small amplitude component from the intermediate-band component extracted by the intermediate bandpass filter; and
an intermediate-band small amplitude adjusting unit that adjusts an intermediate-band small amplitude component extracted by the intermediate-band small amplitude extracting unit,
wherein the adding unit adds the high-band large amplitude component adjusted by the high-band large amplitude adjusting unit, the high-band small amplitude component adjusted by the high-band small amplitude adjusting unit, the intermediate-band large amplitude component adjusted by the intermediate-band large amplitude adjusting unit, and the intermediate-band small amplitude component adjusted by the intermediate-band small amplitude adjusting unit to the input image.

4. The image processing apparatus according to claim 3, further comprising:
an interlocking unit that controls the adjustment of the high-band small amplitude component performed by the high-band small amplitude adjusting unit to be interlocked with the adjustment of the intermediate-band large amplitude component performed by the intermediate-band large amplitude adjusting unit.

5. The image processing apparatus according to claim 1,
wherein frequency bands extracted by the high bandpass filter and the intermediate bandpass filter are determined in cooperation with the number of pixels of the image input by the image input unit and the number of pixels when an image output from the adding unit is displayed.

6. An image processing method comprising:
inputting an image;
extracting an intermediate-band component of the input image;
extracting a large amplitude component from the intermediate-band component extracted in the intermediate-band extracting step;
adjusting an intermediate-band large amplitude component extracted in the intermediate-band large amplitude extracting step;
extracting a high-band component of the input image;
extracting a small amplitude component from the high-band component extracted in the high-band extracting step;
adjusting the high-band small amplitude component extracted in the high-band small amplitude extracting step to be interlocked with the adjustment of the intermediate-band large amplitude component performed in the intermediate-band large amplitude adjusting step; and
adding the high-band small amplitude component adjusted in the high-band small amplitude adjusting step and the intermediate-band large amplitude component adjusted in the intermediate-band large amplitude adjusting step to the input image.

7. A computer program written in a computer readable format, the computer program causing a computer to function as:
an image input unit that inputs an image;
an intermediate-band extracting unit that extracts an intermediate-band component of the input image;
an intermediate-band large amplitude extracting unit that extracts a large amplitude component from the intermediate-band component extracted by the intermediate-band extracting unit;
an intermediate-band large amplitude adjusting unit that adjusts an intermediate-band large amplitude component extracted by the intermediate-band large amplitude extracting unit;
a high-band extracting unit that extracts a high-band component of the input image;
a high-band small amplitude extracting unit that extracts a small amplitude component from the high-band component extracted by the high-band extracting unit;
a high-band small amplitude adjusting unit that adjusts the high-band small amplitude component extracted by the high-band small amplitude extracting unit to be interlocked with the adjustment of the intermediate-band large amplitude component performed by the intermediate-band large amplitude adjusting unit; and
an adding unit that adds the high-band small amplitude component adjusted by the high-band small amplitude adjusting unit and the intermediate-band large amplitude component adjusted by the intermediate-band large amplitude adjusting unit to the input image.
